(19) United States
(12) Patent Application Publication
(10) Pub. No.: US 2014/0299536 A1
(43) Pub. Date: Oct. 9, 2014

(54) DECREASED ADHESION PRESSURE VESSEL FOR BAG-TYPE FILTRATION SYSTEMS

(71) Applicant: 3M INNOVATIVE PROPERTY COMPANY, St. Paul, MN (US)

(72) Inventor: Hideaki Baba, Kanagawa (JP)

(21) Appl. No.: 14/356,194

(22) PCT Filed: Dec. 3, 2012
(86) PCT No.: PCT/US2012/067565

§ 371 Date: May 5, 2014

Related U.S. Application Data
(60) Provisional application No. 61/568,409, filed on Dec. 8, 2011.

(51) Int. Cl. B01D 27/08

(52) U.S. Cl. CPC B01D 27/08
USPC 210/444; 210/435

(57) ABSTRACT

A pressure vessel adapted to hold a compatible filter cartridge encased in a polymeric film is provided. The pressure vessel comprises a pressure vessel outer wall and a pressure vessel inner wall. The pressure vessel inner wall comprises an inner circumference and one or more depressions extending from the inner circumference toward the pressure vessel outer wall, the one or more depressions creating one or more fluid passages between the polymeric film and the pressure vessel when the filter cartridge is installed in the pressure vessel. The one or more depressions comprise a first depression wall joining the pressure vessel inner wall at the inner circumference such that an angle a facing away from the depression between the first depression wall and a tangent of the inner circumference is greater than or equal to ninety degrees.

### BACKGROUND

In certain fluid filtration applications, filtration systems include a fixed or durable pressure vessel along with a disposable filter cartridge that is removable from the pressure vessel. Often, the disposable filter cartridge includes filter media enclosed within an impermeable bag. In such systems, the impermeable bag typically prevents working fluid from escaping from the filter cartridge and wetting the pressure vessel, but is insufficient on its own to withstand the operating pressure of the filtration system. Therefore, the impermeable bag is designed to bear upon the inner walls of the fixed pressure vessel during operation. As a result, the filtration system may safely operate at typical operating pressures while the impermeable bag contains working fluid within the disposable filter cartridge.

However, in such filtration systems, a quantity of working fluid typically remains within the disposable filter cartridge after the filtration operation is complete. Even after the filtration system is depressurized, this residual working fluid continues to bear, under the influence of gravity, against the inner wall of the pressure vessel. As a user attempts to lift the disposable filter cartridge from the pressure vessel, residual working fluid that has collected toward the bottom of the impermeable bag causes the bag to expand against the inner pressure vessel walls. This interaction between the impermeable bag and the walls of the pressure vessel can create a friction or adhesion, making it difficult to pull the disposable filter cartridge from the pressure vessel. Moreover, the expanded bag can create a virtual seal against the pressure vessel, thereby creating a vacuum in the portion of the pressure vessel below the expanded bag. This vacuum can create additional force for the user to work against as he or she attempts to pull the disposable filter cartridge from the pressure vessel.

One approach to addressing the above problems has been to form one or more holes in the bottom of the pressure vessel to allow air to enter from the bottom up as the disposable filter cartridge is lifted, thereby preventing formation of a vacuum. However, such designs create potential pathways for unwanted leakage of working fluid out of the pressure vessel should the impermeable bag rupture or otherwise fail.

There is a need for a pressure vessel for bag-type filtration systems that can allow for easier removal of typical bag-type disposable filter cartridges while allowing for a fluid-tight pressure vessel in the event the bag fails.

### SUMMARY OF THE INVENTION

The present disclosure relates to a pressure vessel that allows for easier removal of typical bag-type filter cartridges while allowing for a fluid-tight pressure vessel in the event the bag fails. Such systems can decrease the effort necessary to remove a disposable bag-type filter from a pressure vessel after a filtration operation.

In one embodiment, the present disclosure provides a pressure vessel adapted to hold a compatible filter cartridge encased in a polymeric film, the pressure vessel comprising a pressure vessel outer wall and a pressure vessel inner wall. In such embodiments, the pressure vessel inner wall may comprise an inner circumference and one or more depressions extending from the inner circumference toward the pressure vessel outer wall, the one or more depressions creating one or more fluid passages between the polymeric film and the pressure vessel when the filter cartridge is installed in the pressure vessel. In such embodiments, the one or more depressions may comprise a first depression wall joining the pressure vessel inner wall at the inner circumference such that an angle a facing away from the depression between the first depression wall and a tangent of the inner circumference is greater than or equal to ninety degrees.

In some such embodiments, the angle a is greater than ninety degrees.

In the above embodiments, the pressure vessel may further comprise a second depression wall joining the pressure vessel inner wall at the inner circumference such that an angle β facing away from the depression between the second depression wall and a tangent of the inner circumference is greater than or equal to ninety degrees.

In some such embodiments, the angle β is greater than ninety degrees.

In the above embodiments, the second depression wall may join the first depression wall.

In some of the above embodiments, the second depression wall is joined to the first depression wall by one or more intermediate depression walls.

In some embodiments, the angle a is different from the angle β.

In some embodiments, the first depression wall comprises a curved profile.

In some embodiments, at least one of the first depression wall and the second depression wall comprises a curved profile.

In some embodiments, at least one of the first depression wall, the second depression wall, and the intermediate depression wall comprises a curved profile.

In some embodiments, the one or more depressions comprise a complete depression profile defined by the first depression wall such that every angle θ facing away from the depression between a tangent to the complete depression profile and a tangent of the inner circumference is greater than or equal to ninety degrees.

In some embodiments, the one or more depressions comprise a complete depression profile defined by the first depression wall and the second depression wall such that every angle θ facing away from the depression between a tangent to the complete depression profile and a tangent of the inner circumference is greater than or equal to ninety degrees.

In some embodiments, the one or more depressions comprise a complete depression profile defined by the first depression wall, the second depression wall, and the one or more intermediate depression walls such that every angle θ facing away from the depression between a tangent to the complete depression profile and a tangent of the inner circumference is greater than or equal to ninety degrees.

In the above embodiments, the depressions are typically of sufficient size such that air at standard temperature and pressure is allowed to travel through the fluid passages while a compatible filter cartridge is being removed from the pressure vessel.

In some embodiments, at least some of the depressions comprise a depression width in a range from about 2 μm to about 100 μm. In some such embodiments, each of the depressions comprises a depression width in a range from about 20 μm to about 80 μm.

In some embodiments, the depressions comprise two or more parallel channels. In some such embodiments, the parallel channels are adjacent and repeat every 500 μm to 2000 μm. In some such embodiments, the parallel channels are aligned with a longitudinal axis of the pressure vessel. In other embodiments, the parallel channels are disposed at an acute angle relative to a longitudinal axis of the pressure vessel.

In some embodiments, the depressions comprise two or more non-parallel channels.

In some embodiments, the depressions comprise a plurality of dimples. In some embodiments, at least some of the depressions surround a plurality of discrete protrusions. In some such embodiments, the discrete protrusions are disposed in a repeating pattern on the pressure vessel inner wall. In some such embodiments, at least some of the discrete protrusions repeat every 500 μm to 2000 μm. In some such embodiments, the discrete protrusions are uniform and repeat every 500 μm to 2000 μm. In one embodiment, the present disclosure provides a filtration system comprising a pressure vessel according to any of the above embodiments and a filter cartridge for installation within the pressure vessel. In such embodiments, the filter cartridge may comprises a filter head comprising a fluid inlet and a fluid outlet, and a filter media attached to the filter head, the filter media being in fluid communication with the fluid inlet and the fluid outlet. The filter cartridge further comprises a polymeric film attached to the filter head and forming a fluid-tight casing around the filter media, the polymeric film comprising an inner film wall facing the filter media and an outer film wall facing the pressure vessel inner wall.

In some embodiments, both the pressure vessel inner wall and the outer film wall comprise one or more depressions. In some such embodiments, depressions on the pressure vessel inner wall and depressions on the outer film wall are misaligned to prevent portions of the polymer film from nesting in the depressions on the pressure vessel inner wall.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESPCRIPTION OF THE DRAWINGS

Throughout the specification, reference is made to the appended drawings, where like reference numerals designate like elements, and wherein:

FIG. 1 is an exploded perspective view of an exemplary filtration system comprising a pressure vessel according to the present disclosure;

FIG. 2 is a cross-section view of the filtration system depicted in FIG. 1 in an assembled state and partially filled with a residual working fluid;

FIG. 3 is a cross-section view taken at Z-Z of FIG. 2 of an exemplary filtration system according to the present disclosure; and

FIGS. 4A-4E and 5 are detailed cross-section views taken at Z-Z of FIG. 2, as called out in FIG. 3, of exemplary pressure vessels according to the present disclosure.

### DETAILED DESCRIPTION OF THE DRAWINGS

Pressure vessels according to the present disclosure may be considered part of a genus of pressure vessels for use with filter cartridges known as “bag-type” filter cartridges. These bag-type filter cartridges typically encase a disposable filtration media inside a flexible bag for insertion into a rigid pressure vessel during operation. The bag serves to contain the working fluid within the filter cartridge 100, while the pressure vessel serves to withstand the working pressure of the filter system, thus preventing the bag from rupturing. The bag and filter cartridge 100 may be discarded after use. Such filter cartridges can be more economical than those with integral pressure vessels, since less material is disposed of when the filter cartridge 100 is spent. Bag-type filter cartridges can also result in faster system cycle times compared against those with exposed media because the bag prevents wetting of the pressure vessel, thereby eliminating the need to clean the pressure vessel between runs. Examples of bag-type filter cartridges and filtration systems, including potential materials of construction, may be found in U.S. Pat. Nos. 5,919,362 to Barnes et al., and 4,836,925 and 4,929,352 to Wolf, the disclosures of which are hereby incorporated by reference in their entirety. Other examples of bag-type filter cartridges and filtration systems, including potential materials of construction, may be found in U.S. Pat. App. Ser. No. 61/375,553 to Baba, filed as PCT App. No. PCT/US2011/047231 and published as PCT Pub. No. WO2012/024128 and U.S. Pub. No. (to be determined), the disclosure(s) of which is(are) hereby incorporated by reference in its(their) entirety.

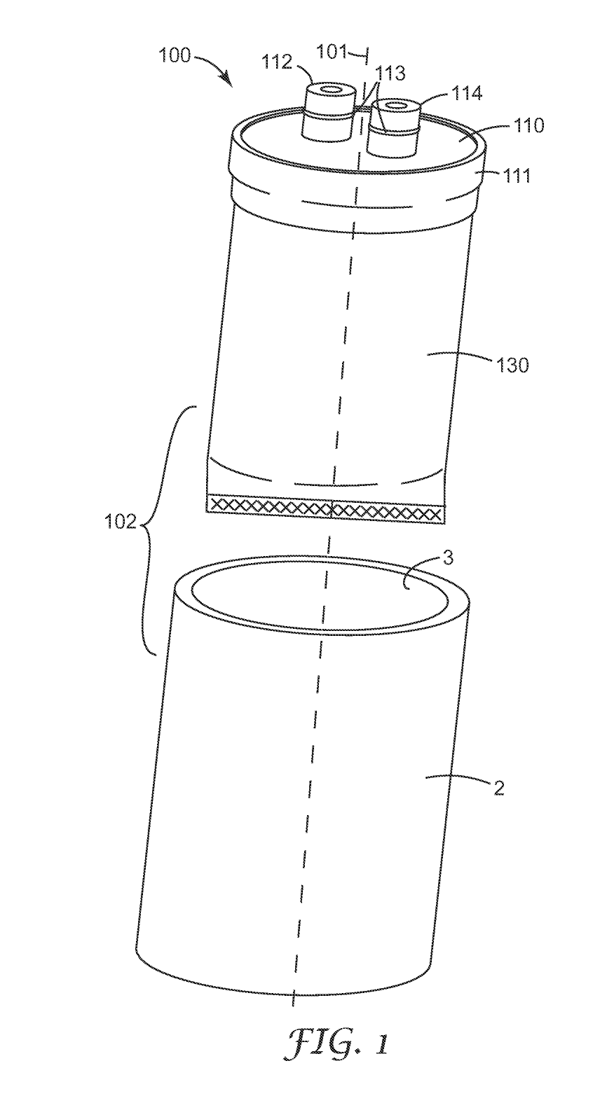

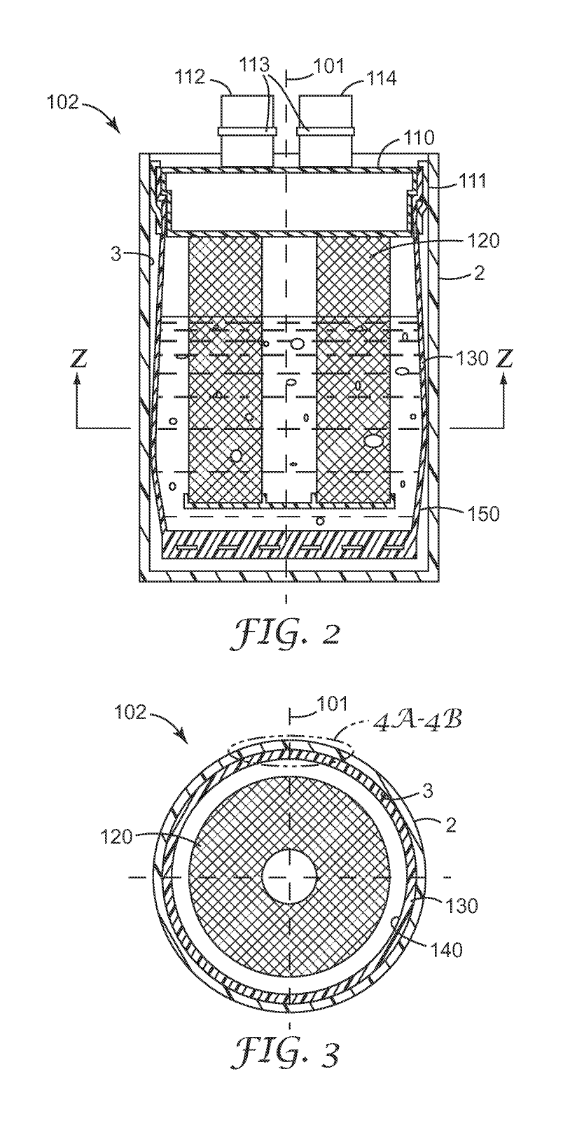

FIG. 1 depicts an exploded filtration system 102 comprising a filter cartridge 100 along with a pressure vessel 2. An assembled, or unexploded, filtration system 102 is depicted in FIGS. 2, 3, and 4A-4E. As shown, filter cartridge 100 can be assembled into a pressure vessel 2 along a longitudinal axis 101 of the pressure vessel. An inlet 112 and an outlet 114 are disposed on a filter head 110.

The filter cartridge 100 comprises a filter head 110 comprising a fluid inlet 112 and a fluid outlet 114. A filter media 120 is secured to the filter head 110 such that a fluid flowing from the fluid inlet 112 to the fluid outlet 114 can flow through the filter media 120. In the embodiment shown, both fluid inlet 112 and fluid outlet 114 comprise a sealing member 113 to allow the filter cartridge 100 to fluidly seal to a compatible filtration manifold (not shown). As shown, sealing member 113 is an o-ring, but could also be a gasket or any other fluid sealing means commonly known in the art. It is noted that the internal configuration of the filter head 110, including fluid paths corresponding to fluid inlet 112 and fluid outlet 114, is not shown. Such particular internal configuration is not important so long as the filter cartridge 100 is capable of allowing a working fluid to pass into the filter cartridge 100, through the filter media 120, and back out of the filter cartridge 100.

The filter media 120 may be any suitable filtration media for the desired application including, for example, a carbon block, pleated filtration media, spirally-wrapped filtration media, or combinations thereof.

A polymeric film 130 is also attached to the filter head 110, encasing the filter media 120. In one embodiment, the polymeric film 130 is secured to the filter head 110 with a retainer 111. The retainer 111, if used, serves to compress the polymeric film 130 against the filter head 110 to prevent bypass of any working fluid. The retainer 111 may be akin to a common sanitary clamp, a hose clamp, a snap ring, or any other mechanical means of creating a fluid-tight seal between the polymeric film 130 and the filter head 110. It is also envisioned that adhesive or heat-bonding may be employed alone or in conjunction with a retainer 111 to provide a seal between the polymeric film 130 and the filter head 110.

As shown in FIG. 1, the polymeric film 130 is sealed opposite the filter head 110 to contain fluid within the filter cartridge 100. Such sealing may be done by simple application of heat, or by ultrasonic welding, adhesives, or other polymer joining methods recognized by those skilled in the art.

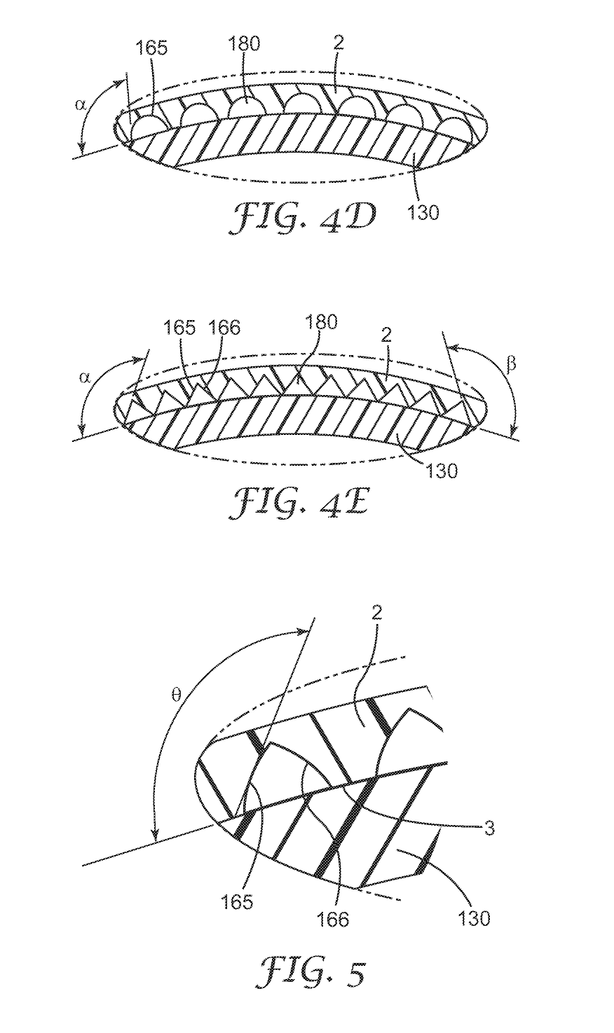

FIGS. 4A through 4E are detailed cross-section views of filtration systems including pressure vessels 2 according to the present disclosure. While not exhaustive, the embodiments shown in these detailed views depict various forms of depressions 160 on the pressure vessel inner wall 3.

FIG. 4A depicts an exemplary polymeric film 130 according to the present disclosure. It can be seen that polymeric film 130 comprises an inner film wall 140 and an outer film wall 150. Here, a plurality of depressions 160 are formed in the pressure vessel inner wall 3. When a filter cartridge comprising a polymeric film having an outer film wall is installed into a pressure vessel 2, these depressions 160 cooperate with the outer film wall to create fluid passages 180 that allow a fluid—typically air—to pass between the polymeric film 130 and the pressure vessel inner wall 3, thus leading to the advantages described herein. In the example shown in FIG. 4A, the depressions 160 are substantially rectangular in profile. The depressions 160 comprise a depression depth 162 and a depression width 163. So long as they fall within the constraints described below, the depressions 160 may be of any size or shape so long as they work in cooperation with the compatible filter cartridge to create one or more fluid passages 180 as described herein.

Because polymeric films used in filter cartridges are generally flexible materials, the films have a tendency to expand outwardly when the filter cartridge is internally pressurized. Therefore, the polymeric film will have a tendency to push, or extrude, into any depressions on the pressure vessel inner wall. Some degree of such extrusion is to be expected and tolerated. However, allowing the size of depressions on the pressure vessel inner wall to be too large may result in the polymeric film completely consuming the depression such that no fluid passage is formed. Moreover, certain shapes of depressions may result in a greater tendency for the polymeric film to “catch” on edges or surfaces of the depression, thereby resulting in increased friction—or even potential film damage—upon attempted removal of the filter cartridge. For these reasons, it is preferred that the depressions comprise (1) a depression width in a range from about 2 micrometers to about 100 micrometers; (2) a depression depth in a range from about 2 micrometers to about 100 micrometers; and (3) a depression shape, or profile, that reduces or minimizes frictional interaction between the depressions and the polymeric film upon filter cartridge removal.

Typical depression shapes, or profiles, to reduce friction include do not comprise “undercuts.” In such preferred depressions, a first depression wall 165 will join the pressure vessel inner wall at its inner circumference such that an angle a facing away from the depression between the first depression wall 165 and a tangent of the inner circumference is greater than or equal to ninety degrees. Examples of this configuration are shown in FIGS. 4A-4E. In such configurations, the polymeric film is discouraged from extruding into the depression to “wrap” around the edge created where the first depression wall 165 meets the inner circumference. Typically, the angle α is greater than ninety degrees, including 95 degrees, 100 degrees, 86 degrees, or any other angle in one-degree increments in a range from 90 degrees to 180 degrees, so long as herein described depth, width, and interval requirements are met for a given depression.

In instances where a depression comprises a non-continuous profile (i.e., a profile wherein one or more vertices is(are) formed by the intersection of non-tangent walls), the depression may comprise a second depression wall 166 joining the pressure vessel inner wall at the inner circumference such that an angle β facing away from the depression between the second depression wall 166 and a tangent of the inner circumference is greater than or equal to ninety degrees. Examples of configurations having a second depression wall 166 are shown in FIGS. 4A-4C and 4E. As with the angle a described above with respect to the first depression wall 165, the polymeric film n such embodiments is discouraged from extruding into the depression to “wrap” around the edge created where the second depression wall 166 meets the inner circumference. Typically, the angle β is greater than ninety degrees, including 95 degrees, 100 degrees, 86 degrees, or any other angle in one-degree increments in a range from 90 degrees to 180 degrees, so long as herein described depth, width, and interval requirements are met for a given depression.

In some such embodiments, the first depression wall 165 joins the second depression wall 166, such that no intermediate depression walls 167 are present. Examples of such configurations are shown in FIGS. 4B, 4C, and 4E.

In some embodiments, one or more intermediate depression walls 167 lie(s) between, and joins, the first depression wall 165 and the second depression wall 166. And example of such a configurations is shown in FIG. 4A.

In some embodiments (not depicted in the appended drawings), the angle α is different from the angle β.

In some embodiments, the first depression wall 165 comprises a curved profile. Examples of such configurations are shown in FIGS. 4C and 4D. In some embodiments, at least one of the first depression wall 165 and the second depression wall 166 comprises a curved profile. In some embodiments, at least one of the first depression wall 165, the second depression wall 166, and the one or more intermediate depression wall(s) 167 comprises a curved profile.

In some embodiments, the one or more depressions comprise a complete depression profile defined by the first (or second, or both) depression wall such that every angle θ facing away from the depression between a tangent to the complete depression profile and a tangent of the inner circumference is greater than or equal to ninety degrees. Said differently, there are no “undercuts” present at any point along the trajectory of the depression profile. An example of such an embodiment is shown in FIG. 5. In some embodiments where one or more intermediate depression walls 167 is (are) present, the one or more depressions comprise a complete depression profile defined by the first depression wall 165, the second depression wall 166, and the one or more intermediate depression walls 167 such that every angle θ facing away from the depression between a tangent to the complete depression profile and a tangent of the inner circumference is greater than or equal to ninety degrees.

Typically, the depression depth 162 is large enough that sufficient fluid passages 180 are created. The depression width 163 is typically in a range from about 2 micrometers (μm) to about 100 μm, including about 5, 10, 20, 30, 40, 50, 60, 70, 80, or 90 μm or any range therein. Similar to the depression depth 162 described above, if the depression width 163 is too small, sufficient fluid passages 180 may not be created. Conversely, if the depression width 163 is too large, the polymeric film of the filter cartridge may collapse outwardly onto the compatible pressure vessel 2, thus closing at least a portion of any fluid passage 180 that may otherwise have been formed.

Although the plurality of depressions 160 in FIG. 4A are depicted as uniformly spaced about the pressure vessel wall inner 3, it is envisioned that any spacing, be it patterned or random, may be employed so long as suitable fluid passages 180 can be formed in cooperation with a compatible filter cartridge. The particular spacing chosen may be selected according to criteria described elsewhere herein.

Similarly, although the plurality of depression 160 in FIG. 4A are depicted as uniform in profile, it is envisioned that any combination of profiles, be it patterned or random, may be employed so long as suitable fluid passages 180 can be formed in cooperation with a compatible filter cartridge. Exemplary profiles are discussed below. It should be understood that the various depression 160 profiles expressly depicted herein are merely examples and are not intended to limit the scope of depression 160 profiles contemplated under the present disclosure.

In FIG. 4C, another embodiment of depressions 160 is depicted. In this case, the one or more depressions 160 are concave in profile, but are uniformly spaced apart from adjacent depressions 160. An alternative to the embodiment of FIG. 4C is shown in FIG. 4E, wherein depressions 160 are triangular in profile. As shown, each depression 160 is immediately adjacent another depression 160 with essentially no space in between. As noted above, it is envisioned that any spacing, be it patterned or random, may be employed so long as suitable fluid passages 180 can be formed in cooperation with a compatible pressure vessel 2.

Any of the depressions 160 depicted, for example, in FIGS. 4B and 4C may be disposed substantially parallel to one another and co-linear with the longitudinal axis 101 of the pressure vessel 2. In such embodiments, the depressions 160 may result in two or more parallel channels in the pressure vessel inner wall 3. However, such parallel channels may alternatively or additionally be disposed at an acute angle to the longitudinal axis 101.

In the alternative, one or more of the depressions 160 may be disposed in a non-parallel fashion with respect to one another. In such embodiments, the depressions 160 may result in two or more non-parallel channels in the pressure vessel inner wall 3. One or more of such non-parallel channels may be disposed either parallel to or at an acute angle to the longitudinal axis 101.

The above depression and channel configurations may be adopted and adjusted to suit a particular application or to give a desired aesthetic affect, so long as suitable fluid passages 180 are formed in cooperation with a compatible filter cartridge. Combinations of the above channel configurations are also envisioned.

In some embodiments (not shown) the depressions 160 surround a plurality of discrete protrusions 170. Discrete protrusions 170 could comprise any profile so long as suitable fluid passages 180 could be formed in cooperation with a compatible pressure vessel 2. For example, a discrete protrusion 170 may comprise a three-dimensional shape such as a cylinder, a cone, or a pyramid. Other, more complex geometries are also envisioned. Whatever the profile, the plurality of discrete protrusions 170 may collectively result in the pressure vessel inner wall 3 having a textured surface providing suitable fluid passages 180 in cooperation with a polymeric film 130.

The depressions 160 may be of any shape or configuration, so long as the fluid passages 180 formed by the cooperation of the depressions 160 and the inner pressure vessel wall 3 allow a fluid—typically air—to pass between the polymeric film 130 and the inner pressure vessel wall 3. The passage of fluid through the fluid passages 180 can prevent the polymeric film 130 from creating a seal against the inner pressure vessel wall 3. Prevention of a seal can prevent formation of a vacuum when the filter cartridge 100 is removed from the compatible pressure vessel 2, thus lessening the force required to remove the filter cartridge 100.

The polymeric film 130 and/or optional backing layer 131 may comprise any suitable polymer composition. In one embodiment, the polymeric film 130 and/or optional backing layer 131 comprises polyethylene. Various potential materials and general filter cartridge 100 configurations are described in U.S. Pat. Nos. 5,919,362 to Barnes et al., and 4,836,925 and 4,929,352 to Wolf, the disclosures of which are hereby incorporated by reference in their entirety.

In one embodiment the polymeric film 130 and/or optional backing layer 131 comprises a polymer having electrically conductive or anti-static properties. Such anti-static constructions may be beneficial, for example, in industrial environments where flammable vapors may be present. By reducing or preventing an electrical charge build-up on the outer film wall 150, the risk of electrical arcing between the polymeric film 130 and the compatible pressure vessel 2 is reduced, thereby lessening the risk of accidental ignition of flammable vapors.

As discussed above, FIG. 1 depicts a filtration system 102 comprising a filter cartridge 100 and a compatible pressure vessel 2 according to the present disclosure. Filter cartridge 100 is shown disassembled from compatible pressure vessel 2 along longitudinal axis 101. As shown, compatible pressure vessel 2 is a simplified blind cylinder with one open end and a pressure vessel inner wall 3.

FIG. 2 is a cross sectional view of the filtration system 102 of FIG. 1 in an assembled state with the filter cartridge 100 inserted into compatible pressure vessel 2. As shown, polymeric film 130 is partially filled with a working fluid, as would be common after use of the filtration system 102. The residual fluid causes the polymeric film 130 to expand radially outwardly and contact the pressure vessel inner wall 3, thereby taking on a somewhat bowed shape as shown. Therefore, the polymeric film 130 will tend to be forced against the pressure vessel inner wall 3 as the filter cartridge 100 is removed from the compatible pressure vessel 2.

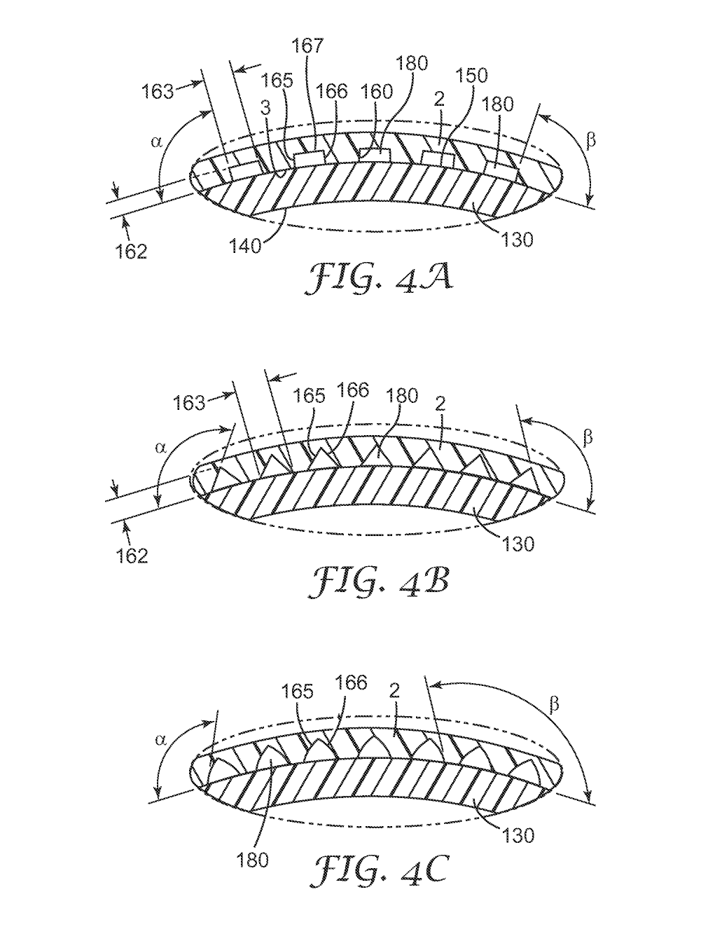

FIG. 3 is a cross-section view taken at Z-Z of FIG. 2 at the point where polymeric film 130 is forced against the pressure vessel inner wall 3. This contact point is further detailed in FIGS. 4A-4E, where the interaction between the polymeric film 130 and the pressure vessel inner wall 3 can be seen. As is clearly shown in these figures, a plurality of fluid passage 180 are formed through cooperation of the polymeric film 130 and the pressure vessel inner wall 3. As earlier described, such fluid passages 180 can allow for easier extraction of the filter cartridge 100 from the compatible pressure vessel 2 due to reduced friction and the prevention of a vacuum.

While the principals discussed above relate generally to pressure vessels comprising depressions 160, it should also be understood that, in other embodiments, similar depressions 160 could be instead provided on polymeric film. So long as suitable fluid passages 180 are formed by cooperation of the polymeric film 130 and the compatible pressure vessel 2, the one or more depressions 160 could be provided on either or both parts.

At least the following exemplary embodiments are envisioned within the scope of the present disclosure:

### Embodiment 1

A pressure vessel adapted to hold a compatible filter cartridge encased in a polymeric film, the pressure vessel comprising:

a pressure vessel outer wall; and

a pressure vessel inner wall comprising an inner circumference and one or more depressions extending from the inner circumference toward the pressure vessel outer wall, the one or more depressions creating one or more fluid passages between the polymeric film and the pressure vessel when the filter cartridge is installed in the pressure vessel;

the one or more depressions comprising a first depression wall joining the pressure vessel inner wall at the inner circumference such that an angle a facing away from the depression between the first depression wall and a tangent of the inner circumference is greater than or equal to ninety degrees.

### Embodiment 2

The pressure vessel of embodiment 1 wherein the angle a is greater than ninety degrees.

### Embodiment 3

The pressure vessel of any of embodiments 1 or 2 further comprising a second depression wall joining the pressure vessel inner wall at the inner circumference such that an angle β facing away from the depression between the second depression wall and a tangent of the inner circumference is greater than or equal to ninety degrees.

### Embodiment 4

The pressure vessel of embodiment 3 wherein the angle β is greater than ninety degrees.

### Embodiment 5

The pressure vessel of any of embodiments 3 or 4 wherein the second depression wall joins the first depression wall.

### Embodiment 6

The pressure vessel of any of embodiments 3 or 4 wherein the second depression wall is joined to the first depression wall by one or more intermediate depression walls.

### Embodiment 7

The pressure vessel of any of embodiments 3-6 wherein the angle a is different from the angle β.

### Embodiment 8

The pressure vessel of any of embodiments 1 or 2 wherein the first depression wall comprises a curved profile.

### Embodiment 9

The pressure vessel of any of embodiments 3-5 wherein at least one of the first depression wall and the second depression wall comprises a curved profile.

### Embodiment 10

The pressure vessel of any of embodiments 6-7 wherein at least one of the first depression wall, the second depression wall, and the intermediate depression wall comprises a curved profile.

### Embodiment 11

The pressure vessel of any of embodiments 1-2 wherein the one or more depressions comprise a complete depression profile defined by the first depression wall such that every angle θ facing away from the depression between a tangent to the complete depression profile and a tangent of the inner circumference is greater than or equal to ninety degrees.

### Embodiment 12

The pressure vessel of any of embodiments 3-5 or 9 wherein the one or more depressions comprise a complete depression profile defined by the first depression wall and the second depression wall such that every angle θ facing away from the depression between a tangent to the complete depression profile and a tangent of the inner circumference is greater than or equal to ninety degrees.

### Embodiment 13

The pressure vessel of any of embodiments 6-7 or 10 wherein the one or more depressions comprise a complete depression profile defined by the first depression wall, the second depression wall, and the one or more intermediate depression walls such that every angle θ facing away from the depression between a tangent to the complete depression profile and a tangent of the inner circumference is greater than or equal to ninety degrees.

### Embodiment 14

The pressure vessel of any of embodiments 1-13 wherein the depressions are of sufficient size such that air at standard temperature and pressure is allowed to travel through the fluid passages while a compatible filter cartridge is being removed from the pressure vessel.

### Embodiment 15

The pressure vessel of any of embodiments 1-14 wherein at least some of the depressions comprise a depression width in a range from about 2 μm to about 80 μm.

### Embodiment 16

The pressure vessel of embodiment 15 wherein each of the depressions comprises a depression width in a range from about 20 μm to about 80 μm.

### Embodiment 17

The pressure vessel of any of embodiments 1-16 wherein the depressions comprise two or more parallel channels.

### Embodiment 18

The pressure vessel of embodiment 17 wherein the parallel channels are adjacent and repeat every 500 μm to 2000 μm.

### Embodiment 19

The pressure vessel of any of embodiments 17-18 wherein the parallel channels are aligned with a longitudinal axis of the pressure vessel.

### Embodiment 20

The pressure vessel of any of embodiments 17-18 wherein the parallel channels are disposed at an acute angle relative to a longitudinal axis of the pressure vessel.

### Embodiment 21

The pressure vessel of any of embodiments 1-20 wherein the depressions comprise two or more non-parallel channels.

### Embodiment 22

The pressure vessel of any of embodiments 1-21 wherein the depressions comprise a plurality of dimples.

### Embodiment 23

The pressure vessel of any of embodiments 1-22 wherein at least some of the depressions surround a plurality of discrete protrusions.

### Embodiment 24

The pressure vessel of embodiment 23 wherein the discrete protrusions are disposed in a repeating pattern on the pressure vessel inner wall.

### Embodiment 25

The pressure vessel of any of embodiments 23-24 wherein at least some of the discrete protrusions repeat every 500 μm to 2000 μm.

### Embodiment 26

The pressure vessel of embodiment 17 wherein the discrete protrusions are uniform and repeat every 500 μm to 2000 μm.

### Embodiment 27

A filtration system comprising:

a pressure vessel according to any of embodiments 1-26; and

a filter cartridge for installation within the pressure vessel, the filter cartridge comprising:
a filter head comprising a fluid inlet and a fluid outlet;
a filter media attached to the filter head, the filter media being in fluid communication with the fluid inlet and the fluid outlet; and
a polymeric film attached to the filter head and forming a fluid-tight casing around the filter media, the polymeric film comprising an inner film wall facing the filter media and an outer film wall facing the pressure vessel inner wall.

### Embodiment 28

The filtration system of embodiment 27 wherein the outer film wall does not comprise any depressions.

### Embodiment 29

The filtration system of embodiment 28 wherein both the pressure vessel inner wall and the outer film wall comprise one or more depressions.

### Embodiment 30

The filtration system of embodiment 29 wherein depressions on the pressure vessel inner wall and depressions on the outer film wall are misaligned to prevent portions of the polymer film from nesting in the depressions on the pressure vessel inner wall.

Various modifications and alterations of the invention will be apparent to those skilled in the art without departing from the spirit and scope of the invention. It should be understood that the invention is not limited to illustrative embodiments set forth herein.

1. A pressure vessel adapted to hold a compatible filter cartridge encased in a polymeric film, the pressure vessel comprising:
a pressure vessel outer wall; and
a pressure vessel inner wall comprising an inner circumference and one or more depressions extending from the inner circumference toward the pressure vessel outer wall, the one or more depressions creating one or more fluid passages between the polymeric film and the pressure vessel when the filter cartridge is installed in the pressure vessel;
the one or more depressions comprising a first depression wall joining the pressure vessel inner wall at the inner circumference such that an angle a facing away from the depression between the first depression wall and a tangent of the inner circumference is greater than or equal to ninety degrees.

2. The pressure vessel of claim 1 wherein the angle α is greater than ninety degrees.

3. The pressure vessel of claim 1 further comprising a second depression wall joining the pressure vessel inner wall at the inner circumference such that an angle β facing away from the depression between the second depression wall and a tangent of the inner circumference is greater than or equal to ninety degrees.

4. The pressure vessel of claim 3 wherein the angle β is greater than ninety degrees.

5. The pressure vessel of claim 3 wherein the second depression wall joins the first depression wall.

6. The pressure vessel of claim 3 wherein the second depression wall is joined to the first depression wall by one or more intermediate depression walls.

7. The pressure vessel of claim 3 wherein the angle a is different from the angle β.

8. The pressure vessel of claim 1 wherein the first depression wall comprises a curved profile.

9. The pressure vessel of claim 3 wherein at least one of the first depression wall and the second depression wall comprises a curved profile.

10. The pressure vessel of claim 6 wherein at least one of the first depression wall, the second depression wall, and the intermediate depression wall comprises a curved profile.

11. The pressure vessel of claim 1 wherein the one or more depressions comprise a complete depression profile defined by the first depression wall such that every angle θ facing away from the depression between a tangent to the complete depression profile and a tangent of the inner circumference is greater than or equal to ninety degrees.

12. The pressure vessel of claim 3 wherein the one or more depressions comprise a complete depression profile defined by the first depression wall and the second depression wall such that every angle θ facing away from the depression between a tangent to the complete depression profile and a tangent of the inner circumference is greater than or equal to ninety degrees.

13. The pressure vessel of claim 6 wherein the one or more depressions comprise a complete depression profile defined by the first depression wall, the second depression wall, and the one or more intermediate depression walls such that every angle θ facing away from the depression between a tangent to the complete depression profile and a tangent of the inner circumference is greater than or equal to ninety degrees.

14. The pressure vessel of claim 1 wherein the depressions are of sufficient size such that air at standard temperature and pressure is allowed to travel through the fluid passages while a compatible filter cartridge is being removed from the pressure vessel.

15. The pressure vessel of claim 1 wherein at least some of the depressions comprise a depression width in a range from about 2 μm to about 100 μm.

16. The pressure vessel of claim 15 wherein each of the depressions comprises a depression width in a range from about 20 μm to about 80 μm.

17. The pressure vessel of claim 1 wherein the depressions comprise two or more parallel channels.

18. The pressure vessel of claim 17 wherein the parallel channels are adjacent and repeat every 500 μm to 2000 μm.

19. The pressure vessel of claim 17 wherein the parallel channels are aligned with a longitudinal axis of the pressure vessel.

20. The pressure vessel of claim 18 wherein the parallel channels are disposed at an acute angle relative to a longitudinal axis of the pressure vessel.

21. The pressure vessel of claim 1 wherein the depressions comprise two or more non-parallel channels.

22. The pressure vessel of claim 1 wherein the depressions comprise a plurality of dimples.

23. The pressure vessel of claim 1 wherein at least some of the depressions surround a plurality of discrete protrusions.

24. The pressure vessel of claim 23 wherein the discrete protrusions are disposed in a repeating pattern on the pressure vessel inner wall.

25. The pressure vessel of claim 23 wherein at least some of the discrete protrusions repeat every 500 μm to 2000 μm.

26. The pressure vessel of claim 17 wherein the discrete protrusions are uniform and repeat every 500 μm to 2000 μm.

27. A filtration system comprising:
a pressure vessel according to claim 1; and
a filter cartridge for installation within the pressure vessel, the filter cartridge comprising:
a filter head comprising a fluid inlet and a fluid outlet;
a filter media attached to the filter head, the filter media being in fluid communication with the fluid inlet and the fluid outlet; and
a polymeric film attached to the filter head and forming a fluid-tight casing around the filter media, the polymeric film comprising an inner film wall facing the filter media and an outer film wall facing the pressure vessel inner wall.

28. The filtration system of claim 27 wherein the outer film wall does not comprise any depressions.

29. The filtration system of claim 28 wherein both the pressure vessel inner wall and the outer film wall comprise one or more depressions.

30. The filtration system of claim 29 wherein depressions on the pressure vessel inner wall and depressions on the outer film wall are misaligned to prevent portions of the polymer film from nesting in the depressions on the pressure vessel inner wall.
